(19) United States
(12) Patent Application Publication
(10) Pub. No.: US 2015/0000568 A1
(43) Pub. Date: Jan. 1, 2015

(54) OPTIMIZATION OF THE PROPERTIES OF ALUMINOUS CEMENTS USING INORGANIC FILLERS

(71) Applicant: Macael, Inc., Los Angeles, CA (US)

(72) Inventors: Eric P. Bescher, Los Angeles, CA (US); Edward K. Rice, Los Angeles, CA (US); Grant M. Kao, Rowland Heights, CA (US)

(21) Appl. No.: 14/487,949

(22) Filed: Sep. 16, 2014

Related U.S. Application Data
(63) Continuation of application No. 13/281,241, filed on Oct. 25, 2011, now abandoned.
(60) Provisional application No. 61/406,495, filed on Oct. 25, 2010.

(51) Int. Cl. C04B 7/32; C04B 18/08

(52) U.S. Cl. CPC C04B 7/323; C04B 18/08
USPC 106/692

(57) ABSTRACT

The carefully controlled addition of inorganic fillers to calcium sulfoaluminate rapid-setting cements can lead to significant improvement and optimization of its properties. Generally, prior art achieves cement optimization using costly and unstable organic additives. In the present invention, the addition of three inorganic additives such as coal ash, limestone or kiln dust led to appreciable improvement in the properties of calcium sulfoaluminate-containing cements. The addition of coal fly ash led to increased compressive strength and freeze-thaw durability while decreasing shrinkage and autoclave expansion. The addition of limestone was shown to control the compressive strength while not affecting the setting time, and the addition of cement kiln dust was shown to control the compressive strength while increasing the setting time. And finally, the presence of a super plasticizing agent was shown to negatively affect both compressive strength and shrinkage when used in combination with fly ash.

### CROSS-REFERENCE TO RELATED APPLICATIONS

This application is a Continuation of U.S. patent application Ser. No. 13/281,241 filed Oct. 25, 2011, and now pending, which claims the benefit of U.S. Provisional Patent Application No. 61/406,495 filed Oct. 25, 2010, now expired. These applications are incorporated herein by reference.

### BACKGROUND OF THE INVENTION

### Field of the Invention

The present invention relates to the field of cement and concrete technology. The present invention uses the addition of inorganic fillers such as fly ash, limestone, and cement kiln dust to calcium sulfoaluminate cement and concrete to optimize compressive strength, shrinkage, freeze thaw resistance, and autoclave expansion.

### Fly Ash

Fly ash is the byproduct from coal-fired electric generating plants formed during the combustion of coal. Fly ash is the fine particulate matter that rises with the exhaust gasses during the combustion process. This suspended particulate matter is termed fly ash and the remaining ash left over is referred to as bottom ash. Up until the mid 1960s, fly ash was simply vented into the atmosphere until the Federal Clean Air Act was amended, regulating these types of emissions. With collection of these particles now being mandated, large amounts of fly ash began accumulating. Small quantities of this waste product began being used as cheap filler in cement and concrete products. This use of fly ash in cementitious construction materials has steadily grown over the past several decades. However, despite this increased utilization, 60% of the generated fly ash currently produced is being disposed of in landfills. And from current production and utilization data, production of fly ash is outgrowing its use. In 2009, 63 million tons of fly ash were produced in the United States.

Different types of coal generate different types of fly ash with different chemical compositions, causing different chemical reactions with cement. Due to the varying compositions and increasing use of fly ash in the cement and concrete industries, the American Society for Testing and Materials (ASTM) included a specification for fly ash. The ASTM specification covers coal fly ash as well as other natural Pozzolan for the use in cement, designating two classes of coal fly ash: Class F and Class C. This specification sets requirement for minimum and maximum chemical content of SiO₂, Al₂O₃, Fe₂O₃, and SO₃ as well as maximum values for physical properties such as fineness. Class F fly ash is said to be rarely cementitious when mixed with water alone, while Class C fly ash is said to have cementitious properties.

Generally, fly ash particles are made of spherical particles called cenospheres. The characteristics of these particles is especially relevant to the present invention, as it has been observed that when fly ash is mixed with calcium sulfoaluminate (CSA) cement, the hydration product of the CSA cement, namely, ettringite needles, attach themselves to the surface of the cenospheres, forming heretofore never observed microstructures that are believed to increase the strength of the cement through improved organization of the cement hydration products. Without wishing to be bound by this theory, these unique microstructures are certainly unique to CSA/fly ash cements and appear to play a role in early strength gain of the cement, mortar or concrete.

These unusual microstructures can be observed via electronic microscopy or other techniques. X-Ray diffraction indicates they may play a catalytic effect in the formation of ettringite in the cement.

### Cement Kiln Dust

Like fly ash, cement kiln dust (CKD) is regulated by the United States Environmental Protection Agency (EPA). In 1976, Congress passed the Resource Conservation and Recovery Act (RCRA) to regulate, identify, and manage hazardous waste. There were six categories of waste that were proposed, with CKD being one of them. When cement is fired in large rotary kilns to form clinker, large amounts of dust are produced in the process. This dust is collected via air pollution control devices, much in the way that fly ash in collected and stored. Since much of this kiln dust is non-reacted raw material, most of the CKD collected is recycled back into the kiln. However, a large portion of this dust is deemed not suitable for direct recycling and ends up being disposed of in a landfill. Most of the CKD that is not disposed of is used for stabilization of soils, stabilization/solidification of waste materials, cement additive/blending, and mine reclamation. Just as there are differences in the composition and quality of fly ash, CKD has this same variation and can come in various chemical compositions and fineness.

### Limestone

In the same manner that fly ash and cement kiln dust have been added to cement and concrete as an economic filler, limestone or calcium carbonate can also be added, either blended or interground.

### Prior Art

Before federally mandated regulation and collection of fly ash was instituted, small quantities of fly ash were being collected in the United States and studied in the early 1930s. The U.S. Bureau of Reclamation approved the first major use of fly ash in OPC in 1948 with the construction of the Hungry Horse Dam. This project used 120,000 tons of fly ash, replacing 30% of the cement with inexpensive waste material. Besides the cost benefit of using less cement, the project also was able to cut costs associated with cooling the concrete. As cement sets, heat is released in the reaction. The thick walls of the dam compact this heat, making it necessary to cool the cement to prevent failure of the material. Adding fly ash reduced this accumulation of heat in the concrete walls and allowed for fewer water-cooling pipes to be installed. The construction of this dam with such large percentages of fly ash was the first real proving ground for the wide-scale use of this new material.

It was not soon after this large-scale experiment that other beneficial properties of fly ash were recognized. One of these other advantages of using fly ash was an increase in ultimate compressive strength. When certain fly ash was used, equivalent strengths were obtained compared to cement samples containing no fly ash at ages less than 90 days. In addition, the ultimate strengths of these samples were higher compared to the ultimate strength of the neat cement samples. Obtaining equivalent earlier strengths while using less cement was (and still is) extremely economical, considering fly ash is appreciably less expensive than OPC. Many state and federal departments of transportation now use and encourage use of fly ash in the construction of new roads and highways. Up until now, however, the addition of fly ash to modify such properties has only been carried out in OPC.

The addition of CKD, as previously mentioned, has also been used as an economic filler for OPC. Studies were reported that CKD could be used for up to 15% replacement of Portland cement, but anything above this limit would retard setting times, reduce workability, and increase water demand [Ravindrarajah, R. S, “Usage of Cement Kiln Dust in Concrete,” International Journal of Cement Composites and Lightweight Concrete, Harlow, U.K., Vol. 4, No. 2, May 1982]. Additional studies have reported a drop in compressive strength associated with the addition of CKD. This reduction in compressive strength was attributed to high concentrations of alkalis in the kiln dust when more than 15% of the cement was replaced with CKD [Abo-El-Enein, S. A. Hekal, E. E.; Gabr, N. A.; and El-Barbary, M. I., “Blended Cements Containing Cement Kiln Dust,” Silicates Industrials, Vol. 59, No. 9-10, 1994].

Limestone can be interground or blended into the prior art, OPC. The addition of limestone to OPC yields various effects on the cement's particle size distribution, workability, setting time, heat generation, compressive strength, and freeze-thaw resistance. The ASTM C150 protocol allows up to 5% limestone replacement of OPC by weight. Any limestone replacements above 5% would alter the chemical and physical aspects of the blended material and would fail to meet the ASTM specification.

Even though fly ash has been used in the past to achieve greater strength in OPC, the chemistry involved in calcium sulfoaluminate (CSA) cement is entirely different. As it will be shown, the mechanism for early strength development in CSA cements is very different from that of OPC cement and as a result, the microstructures of the cements are completely different. OPC does not gain appreciable compressive strength for 3 days while CSA cement may achieve 6,000 psi with one hour of hydration under the appropriate protocols. This early strength is due to the formation of ettringite, a phase which is not present in OPC. In the present invention, the formation of novel microstructures based on ettringite and fly ash is observed in the cement. It should also be noted that the true increase in compressive strength associated with OPC cement comes at late stages of hydration, usually 90 days or later. This compressive strength increase in OPC cement is largely associated with the reduction of water due to the spherical shape of the fly ash particles.

As previously mentioned, when used with OPC, CKD typically cannot be used above 15% replacement. Exceeding this limit with OPC results in a reduction of setting time and workability while increasing the water demand of the mix. However, in CSA cement, it will be shown that CKD replacement can be as high as 50% while still maintaining the compressive strength required in the ASTM C150 specification. Similarly, when used with OPC, limestone can be used to replace only 5% of the cement based on ASTM C150. However, since CSA cement is not constricted by this protocol, it will be shown that limestone of up to 35% can be replaced while still achieving comparable compressive strengths.

### BRIEF DESCRIPTION OF THE DRAWINGS

FIG. 1 is a scanning electron microscope image of the cement paste without the super plasticizer.

FIG. 2 is a scanning electron microscope image of the cement paste with the super plasticizer.

FIG. 3 is the quantitative x-ray analysis of the formation of ettringite.

FIG. 4 is a graph showing shrinkage from the addition of fly ash without a super plasticizer.

FIG. 5 is a graph showing shrinkage from the addition of fly ash with a super plasticizer.

### DETAILED DESCRIPTION

### Testing Protocols used in this Application

Autoclave expansion: a standard test method using ASTM C151 to index the potentially delayed expansion caused by the hydration of calcium oxide, magnesium oxide, or both, in hydraulic cement.

Compressive strength: the physical property obtained through ASTM C109 which is the standard test method for determining compressive strength of hydraulic cement mortars.

Freeze—thaw resistance: the physical property obtained through ASTM C666 which is the standard test method for determining the resistance of concrete to rapid freezing and thawing.

Setting time: the physical property obtained through ASTM C191 which is the standard test method for determining the interval of time between initial hydration of the cement and the time when the mix is no longer workable.

Shrinkage: the physical property obtained through ASTM C157 which is the standard test method for determining the length change of hardened hydraulic cement, mortar, and concrete during curing.

### Acronyms used in this Application

CKD: Cement kiln dust.

CSA: Calcium sulfoaluminate.

OPC: Ordinary Portland cement.

w/c: Water-to-cement ratio.

### Example 1

### Compressive Strength (Fly Ash)

The compressive strength increase observed with the addition of fly ash was tested using standard 2-inch mortar cubes using ASTM C109 protocol. Two different types of fly ash were used—Class F and Class C fly ash with the composition of each fly ash shown in Table 1, which displays the chemical analysis of the two different types of fly ash. (Values in weight percent.)

TABLE 1

| Class | SiO₂ | Al₂O₃ | Fe₂O₃ | CaO | MgO | SO₃ | Na₂O | K₂O | L.O.I. |
|---|---|---|---|---|---|---|---|---|---|
| F | 59.20 | 23.53 | 5.04 | 5.68 | 1.00 | 0.25 | 0.00 | 0.00 | 0.92 |
| C | 41.16 | 16.26 | 7.02 | 26.03 | 5.58 | 2.86 | 0.00 | 0.00 | 1.35 |

Two general mix designs were used, one without the presence of a melamine based super plasticizing agent (Table 2, which displays the mix designs for the samples without the super plasticizer) and one with the presence of the super plasticizer (Table 3, which displays the mix designs for the samples with the super plasticizer).

TABLE 2

| | | Fly Ash | Super P | RSC | Sand |
|---|---|---|---|---|---|
| Mix Design | w/c | (grams) | (grams) | (grams) | (grams) |
| 100% RS Cement | 0.4 | 0 | 0 | 1000 | 1000 |
| 90% RS Cement + | 0.4 | 100 | 0 | 900 | 1000 |
| 10% Fly Ash | | | | | |
| 80% RS Cement + | 0.4 | 200 | 0 | 800 | 1000 |
| 20% Fly Ash | | | | | |
| 70% RS Cement + | 0.4 | 300 | 0 | 700 | 1000 |
| 30% Fly Ash | | | | | |

TABLE 3

| | | Fly Ash | Super P | RSC | Sand |
|---|---|---|---|---|---|
| Mix Design | w/c | (grams) | (grams) | (grams) | (grams) |
| 100% RS Cement | 0.4 | 0 | 18.0 | 982.0 | 1000 |
| 90% RS Cement + | 0.4 | 98.2 | 18.0 | 883.8 | 1000 |
| 10% Fly Ash | | | | | |
| 80% RS Cement + | 0.4 | 196.4 | 18.0 | 785.6 | 1000 |
| 20% Fly Ash | | | | | |
| 70% RS Cement + | 0.4 | 294.6 | 18.0 | 687.4 | 1000 |
| 30% Fly Ash | | | | | |

The particular super plasticizer used in this experiment was Melment F10. The water-to-cement ratio (w/c) for all samples was 0.40. The rapid-setting cement was replaced with fly ash of 10, 20, and 30 weight percent. Each of the fourteen mix designs was tested at 1.5, 3.0, and 24 hours after initial hydration. Looking at the samples without a super plasticizer (Table 4, which displays the compressive strength values for the cubes without the super plasticizer), the samples had an increase in compressive strength when compared to the witness sample.

TABLE 4

| | | | | 1.5 Hour | 3.0 Hour | 24 Hour |
|---|---|---|---|---|---|---|
| | Fly ash | Initial Set | Final Set | Strength | Strength | Strength |
| | (weight %) | (minutes) | (minutes) | (psi) | (psi) | (psi) |
| Wit- | 0 | 15 | 18 | 5203 | 5702 | 7518 |
| ness | | | | | | |
| Class | 10 | 13 | 15 | 4980 | 6388 | 6545 |
| F | 20 | 11 | 20 | 5695 | 7352 | 8568 |
| | 30 | 11 | 19 | 5512 | 6677 | 6955 |
| Class | 10 | 12 | 16 | 5505 | 6298 | 7883 |
| C | 20 | 10 | 13 | 5475 | 6542 | 5163 |
| | 30 | 9 | 15 | 5507 | 6520 | 7758 |

However, when looking at the samples with a super plasticizer (Table 5, which displays the compressive strength values for the cubes with the super plasticizer), the samples had a decrease in compressive strength compared to the witness sample.

TABLE 5

| | | | | 1.5 Hour | 3.0 Hour | 24 Hour |
|---|---|---|---|---|---|---|
| | Fly ash | Initial Set | Final Set | Strength | Strength | Strength |
| | (weight %) | (minutes) | (minutes) | (psi) | (psi) | (psi) |
| Wit- | 0 | 26 | 34 | 5807 | 6747 | 7928 |
| ness | | | | | | |
| Class | 10 | 24 | 27 | 5932 | 6570 | 7263 |
| F | 20 | 25 | 33 | 5027 | 5093 | 7372 |
| | 30 | 21 | 30 | 4873 | 6155 | 7330 |
| Class | 10 | 20 | 26 | 5210 | 5787 | 6740 |
| C | 20 | 13 | 19 | 5182 | 5748 | 6977 |
| | 30 | 11 | 19 | 4912 | 5685 | 7137 |

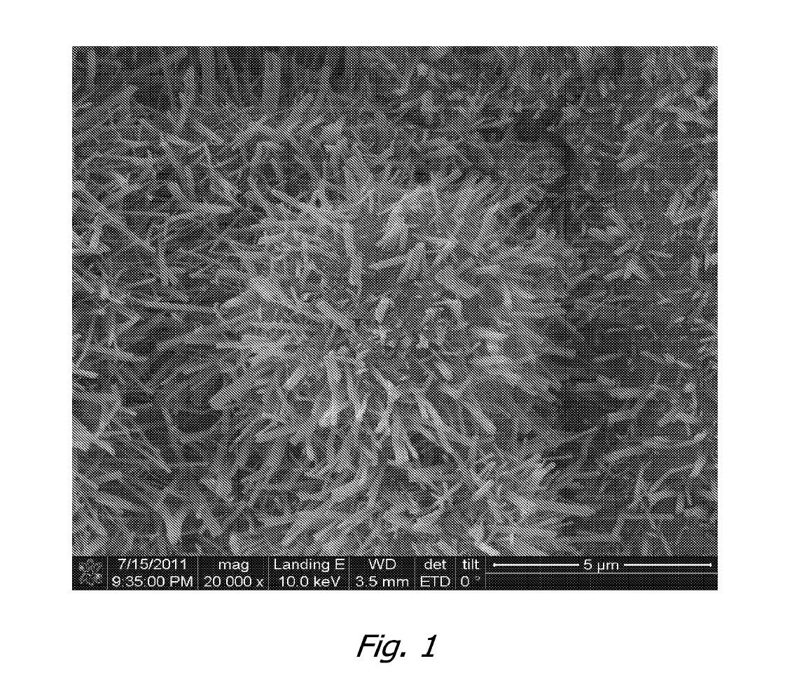

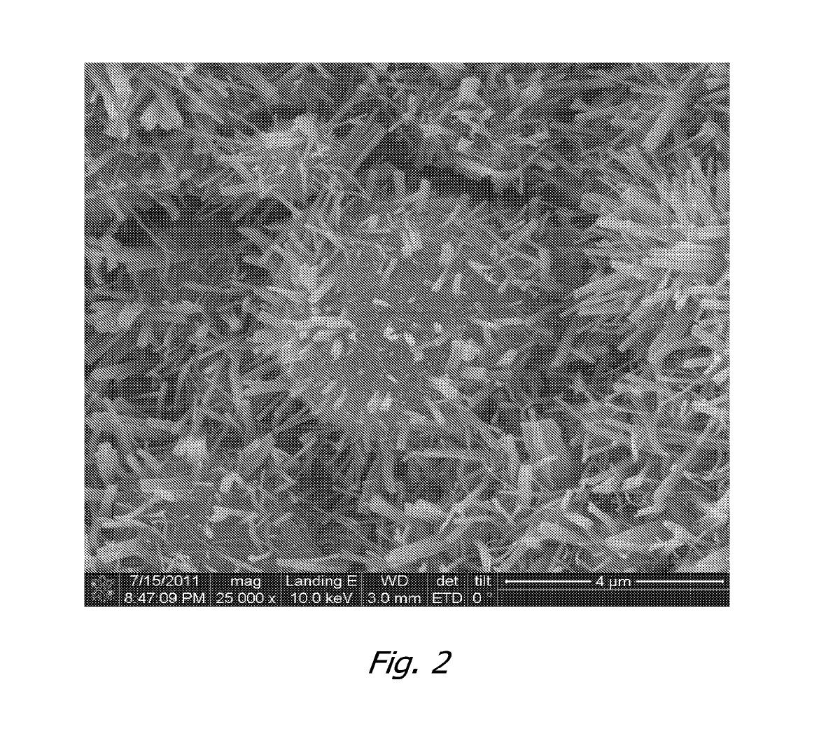

In the present invention, the mechanism believed to produce the additional strength with fly ash relies on the nucleation and growth of ettringite needles on the surface of the fly ash particles (FIG. 1). The addition of a super plasticizer is believed to coat the surface of the suspended fly ash particles in the hydrated cement paste, prohibiting nucleation and growth of these structures (FIG. 2). It is believed that these structures interlock with each other, providing additional strength to the material. Inhibiting the growth of these structures will therefore lessen or negate this strengthening mechanism.

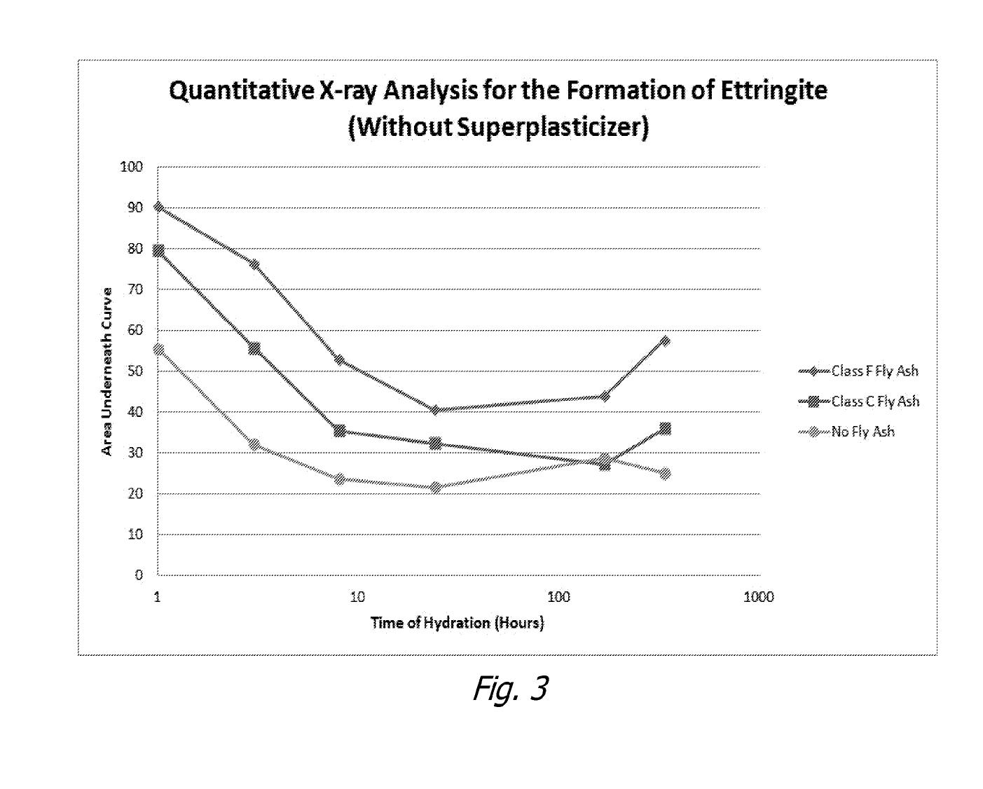

The use of x-ray diffraction was used to quantify the presence of ettringite for the various mix designs with and without the presence of a super plasticizer. When the analysis was complete, the results showed that more ettringite was formed with the witness samples than the samples containing fly ash. However, when the data was normalized to take into account the decrease in cement content, the fly ash samples were shown to contain more ettringite (FIG. 3). This normalized data suggests two important pieces of information: (1) the presence of fly ash increases the production of ettringite needles per gram of cement, and (2) the fly ash samples are achieving higher compressive strength values with less ettringite. The second statement also supports the earlier claim mentioned above: the fewer needles present in the fly ash samples are organizing themselves in a manner to increase the mechanical behavior of the material.

### Example 2

### Compressive Strength (Limestone)

The controlled addition of limestone to CSA cement controls the compressive strength without affecting the setting time. It allows the adjustment of the strength to a given specification as seen in Table 6, which displays the compressive strength values for mortar cubes with additions of limestone.

TABLE 6

| | | | 2.0 Hour | 3.0 Hour | 24 Hour |
|---|---|---|---|---|---|
| Limestone | | Initial Set | Strength | Strength | Strength |
| (weight %) | w/c | (minutes) | (psi) | (psi) | (psi) |
| 0 | 0.4 | 16 | 3200 | 5150 | 6500 |
| 20 | 0.4 | 13 | 2835 | 4180 | 4800 |
| 25 | 0.4 | 14 | 2498 | 3652 | 4468 |
| 30 | 0.4 | 19 | 2578 | 3740 | 4930 |
| 35 | 0.4 | 13 | 2400 | 3330 | 3800 |

As the amount of limestone dosage increased in the mixture, the setting times did not significantly change. The minimum and maximum setting times were 13 and 19 minutes respectively. This ability to control the compressive strength of the material without affecting setting time provides a low cost filler solution for rapid-setting CSA cement products. The compressive strengths at later ages do decrease slightly compared to a mixture without limestone, but 24-hour compressive strength values of 3,800 to 4,800 psi are acceptable in most applications. Applications which require higher compressive strength are rare.

### Example 3

### Compressive Strength (Kiln Dust)

The controlled addition of CKD to CSA cement controls the compressive strength while increasing the setting time. It allows the adjustment of the strength to a given specification as seen in Table 7, which displays the compressive strength values for mortar cubes with additions of kiln dust.

TABLE 7

| | | | Strength | Strength | Strength | Strength |
|---|---|---|---|---|---|---|
| | | Initial | at 3.0 | at 6.0 | at 24 | at 7 |
| Kiln Dust | | Set | Hours | Hours | Hours | Days |
| (weight %) | w/c | (minutes) | (psi) | (psi) | (psi) | (psi) |
| 0 | 0.4 | 12 | 5995 | 6440 | 7120 | 10040 |
| 20 | 0.4 | 31 | 4338 | 5580 | 7500 | 10160 |
| 35 | 0.4 | 41 | 2100 | 4010 | 6130 | 7860 |
| 50 | 0.4 | 65 | 165 | 3510 | 5630 | 6450 |

Kiln dust is another low cost filler solution which can extend initial set and working time, allowing users a longer time before the cement becomes unworkable. Even with the substantial replacement of up to 20% of CKD, the compressive strength values at 24 hours and 7 days remain comparable to the witness sample containing no CKD. Even replacements as high as 50% still achieved impressive strengths with a 7-day compressive strength of 6,450 psi.

### Example 4

### Shrinkage

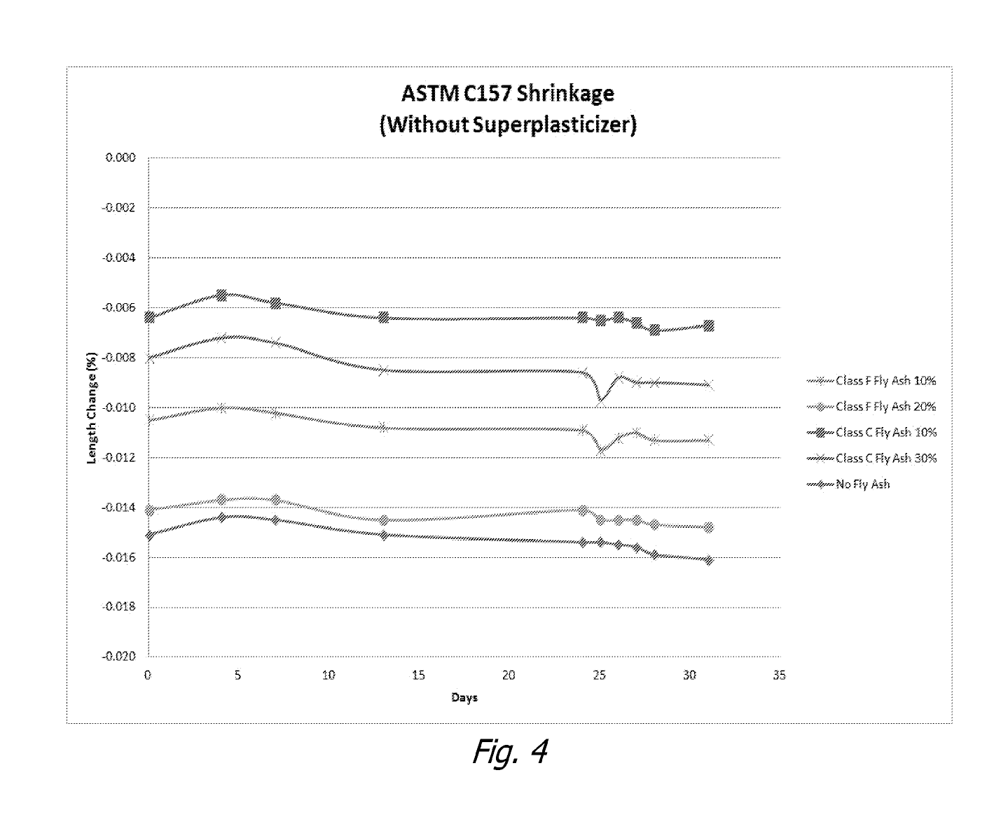

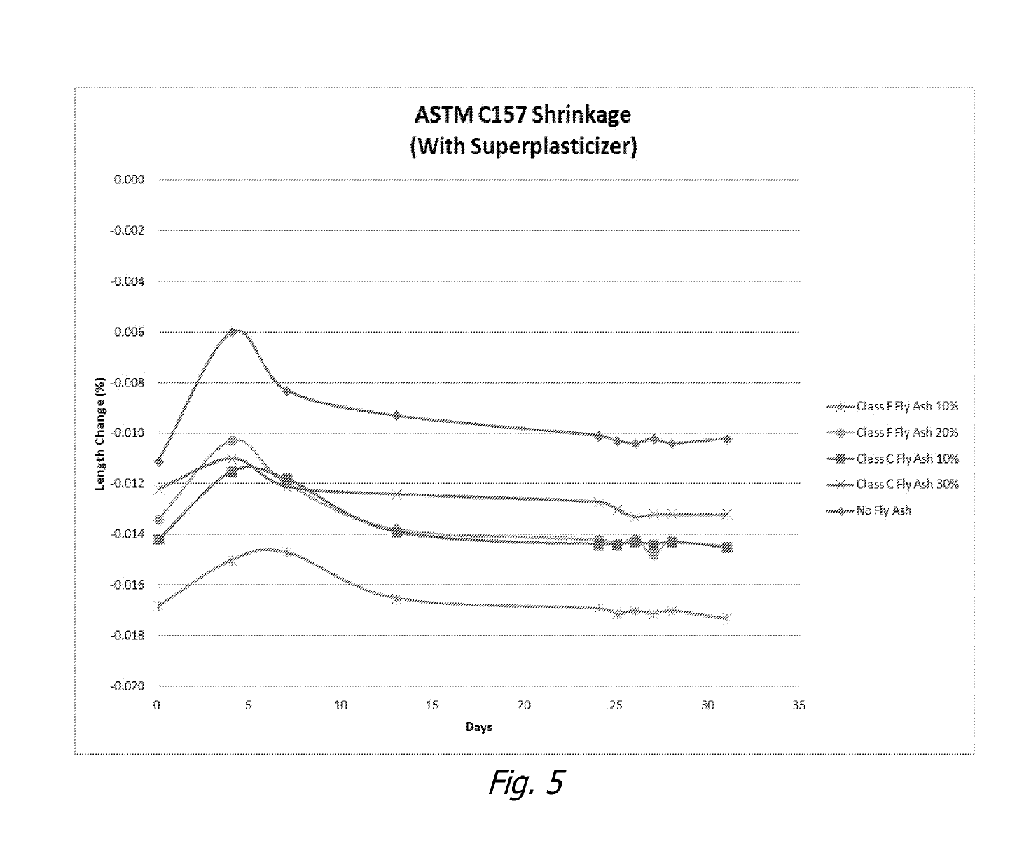

Shrinkage was tested using the ASTM C157 standard. The specimens were made using the same fly ash mix proportions listed in Tables 2 and 3 using ASTM C109 both with and without a super plasticizer. The addition of fly ash in the absence of a super plasticizer significantly lowered shrinkage in most cases, as seen in FIG. 4. However, when fly ash was added in combination with a super plasticizer, this decrease in shrinkage was no longer achieved, as seen in FIG. 5.

### Example 5

### Autoclave Expansion

Autoclave expansion testing was conducted in accordance with the ASTM C151 standard. This test takes a neat cement sample to provide results on potential delayed expansion caused by the hydration of CaO or MgO. The mix designs along with the test results are exhibited in Table 8, which displays autoclave with a passing/failing grade based on ASTM C151.

TABLE 8

| | Fly Ash | Cement | Fly Ash | Water | AC result |
|---|---|---|---|---|---|
| | (weight %) | (grams) | (grams) | (mL) | (+/−/F) mm |
| Witness | 0 | 400 | 0 | 132.5 | Failed |
| Class F | 10 | 360 | 40 | 132.5 | Pass, −0.021% |
| | 20 | 320 | 80 | 132.5 | Pass, −0.031% |
| | 30 | 280 | 120 | 132.5 | Pass, −0.015% |
| Class C | 10 | 360 | 40 | 132.5 | Pass, −0.050% |
| | 20 | 320 | 80 | 132.5 | Pass, −0.054% |
| | 30 | 280 | 120 | 132.5 | Pass, −0.045% |

The water was kept constant with replacements of fly ash of 10, 20, and 30%. The neat CSA cement alone did not pass the autoclave test due to high MgO content. However, the samples containing fly ash passed.

### Example 6

### Freeze-Thaw Resistance

Freeze-thaw resistance was tested using the New York standard test method 502-3P. This standard test method is used to correlate durability of cement and concrete mixtures when exposed to alternating environments which have drastic freezing and thawing climates. Three mix designs were made for the freeze-thaw testing as shown in Table 9, which displays freeze-thaw measured in grams for each sample. (Values in weight percent.)

TABLE 9

| | | 0 Cycles | | |
|---|---|---|---|---|
| | | Sample A | Sample B | |
| Mix | Solution | (grams) | (grams) | % Loss |
| No Fly | NaCl | 1685.1 | 1723.5 | 0 |
| Ash | CaCl₂ | 1735.3 | 1724.3 | 0 |
| 35% Fly | NaCl | 1738.9 | 1727.5 | 0 |
| Ash | CaCl₂ | 1734.5 | 1734.4 | 0 |
| 40% Fly | NaCl | 1703.9 | 1703.9 | 0 |
| Ash | CaCl₂ | 1712.8 | 1705.6 | 0 |
| | | 6 Cycles | | |
| | | Sample A | Sample B | |
| Mix | Solution | (grams) | (grams) | % Loss |
| No Fly | NaCl | — | — | — |
| Ash | CaCl₂ | — | — | — |
| 35% Fly | NaCl | 1742.5 | 1730.1 | 0.18% |
| Ash | CaCl₂ | 1737.6 | 1738 | 0.19% |
| 40% Fly | NaCl | 1709.1 | 1709.4 | 0.31% |
| Ash | CaCl₂ | 1717.1 | 1709.5 | 0.24% |
| | | 14 Cycles | | |
| | | Sample A | Sample B | |
| Mix | Solution | (grams) | (grams) | % Loss |
| No Fly | NaCl | 1678.0 | 1715.9 | −0.43% |
| Ash | CaCl₂ | 1670.8 | 1689.6 | −2.86% |
| 35% Fly | NaCl | 1742.5 | 1730.0 | 0.18% |
| Ash | CaCl₂ | 1736.6 | 1737.9 | 0.16% |
| 40% Fly | NaCl | 1707.8 | 1708.2 | 0.24% |
| Ash | CaCl₂ | 1700.4 | 1707.3 | −0.31% |
| | | 25 Cycles | | |
| | | Sample A | Sample B | |
| Mix | Solution | (grams) | (grams) | % Loss |
| No Fly | NaCl | 1484.1 | 1457.3 | −13.69% |
| Ash | CaCl₂ | 1249.6 | 1424.0 | −22.70% |
| 35% Fly | NaCl | 1738.7 | 1724.2 | −0.10% |
| Ash | CaCl₂ | 1733.5 | 1735.5 | 0.00% |
| 40% Fly | NaCl | 1702.1 | 1702.5 | −0.09% |
| Ash | CaCl₂ | 1686.5 | 1703.0 | −0.84% |

All samples contained 34.18% silica sand per ASTM C33, and all samples contained 45.77% one-inch rock aggregate with a water-to-cement ratio of 0.43. At the start of the test, samples were immersed in two different solutions of calcium chloride and sodium chloride. The weight loss of each sample was measured at various cycles. The test calls for a maximum of 25 cycles. Table 9 exhibits all the percent weight loss of each sample. At 25 cycles, samples with fly ash replacements had less than 1% weight loss from the freeze thaw cycles, showing great durability in rigorous freeze-thaw environments.

### CONCLUSIONS

The early compressive strength of a CSA cement can be appreciably optimized by the addition of up to 30% fly ash of any classification (Table 3). The resulting cement passes autoclave testing due to the addition of the coal fly ash, and when tested using ASTM C 157, and exhibits a shrinkage of less than 0.02% at 28 days. While 30 wt is preferred, fly ash contents up to 70% are within the scope of this invention. Preferably but not necessarily, the coal fly ash is added in an amount of at least 5% by weight.

Table 4 indicates that the substitution of some rapid setting calcium sulfoaluminate cement for fly ash of any type in the 10-30 wt % range increases the 1.5 hour, 3 hr or 24hr strength by at least 500 to 1000 psi, and can be as much as 1,500 psi.

The addition of blended or interground limestone or calcium carbonate in the 10-40% range allows the optimization (decrease) of the compressive strength of cement by about 500 psi for each 5% limestone added, without appreciable effect on the rapid-setting nature of the cement (the setting time remains unchanged with increasing limestone addition). The resulting compressive strength ranges from 2,400 to 2,800 psi at 2 hours and the setting time is between 10 and 20 minutes.

The addition of cement kiln dust in the 10-50wt % range allows the optimization of both strength and setting times of a rapid-setting calcium sulfoaluminate cement (Table 7). When the kiln dust content is approximately 20%, one obtains a 3 hour strength of approximately 4,300 psi, a 6 hour strength of approximately 5,500 psi, and a 24 hour strength of approximately 6,100 psi, with an initial set of 20 minutes.

The addition of up to 40% fly ash of any type allows a calcium sulfoaluminate-cement failing the autoclave test to pass (Table 8).

The claims of this patent include the optimization of a rapid-setting calcium sulfoaluminate cement with the controlled addition of inorganic fillers such as fly ash, limestone, and cement kiln ash. The addition of coal fly ash led to increased compressive strength and freeze-thaw durability while decreasing shrinkage and autoclave expansion. The addition of limestone was shown to control the compressive strength while not affecting the setting time, and the addition of cement kiln dust was shown to control the compressive strength while increasing the setting time. And finally, the presence of a super plasticizing agent was shown to negatively affect both compressive strength and shrinkage when added to samples containing fly ash.

It is understood that changes in the chemical composition of the cement may lead to corresponding changes in the properties of the mortars and concrete made with such modified cement. Thus while certain preferred embodiments of the present invention have been disclosed and described herein for purposes of illustration and not for purposes of limitation, it will be understood by those skilled in the art that various changes in form and detail may be made therein without departing from the spirit and scope of the invention.

What is claimed is:

1. A rapid-setting material consisting of calcium sulfoaluminate cement and coal fly ash, the amount of coal fly ash being up to 30% by weight of the material.

2. The material of claim 1 wherein the coal fly ash content is at least approximately 5% by weight.

3. The material of claim 1 wherein the amount of coal fly ash is 10-30 wt % coal fly ash, whereby the resulting 1.5 hour, 3 hour or 24 hour compressive strength is increased by 500 to 1,000 psi compared to the strength of the pure calcium sulfoaluminate-containing cement.

4. The material of claim 1 which passes autoclave testing due to the addition of coal fly ash.

5. The material of claim 1 in which ettringite content has increased after hydration, when compared to calcium sulfoaluminate cement without coal fly ash.

6. The cement of claim 1 which, when tested using ASTM C 157, exhibits a shrinkage of less than 0.02% at 28 days.

7. A rapid-setting material comprising calcium sulfoaluminate cement and coal fly ash in an amount up to 30% by weight, the material containing microstructures including ettringite bonded to fly ash particles.
